(19) United States
(12) Patent Application Publication
(10) Pub. No.: US 2016/0100457 A1
(43) Pub. Date: Apr. 7, 2016

(54) Heating Mat

(71) Applicants: Kenneth Cole, Converse, TX (US); Willette Paulita Cole, Converse, TX (US); Kenneth Cole, III, Converse, TX (US)

(72) Inventors: Kenneth Cole, Converse, TX (US); Willette Paulita Cole, Converse, TX (US); Kenneth Cole, III, Converse, TX (US)

(21) Appl. No.: 14/874,752

(22) Filed: Oct. 5, 2015

Related U.S. Application Data
(60) Provisional application No. 62/059,326, filed on Oct. 3, 2014.

(51) Int. Cl. H05B 3/36; E01C 11/24

(52) U.S. Cl. CPC H05B 3/36; E01C 11/24; H05B 2203/00

(57) ABSTRACT

A heating mat for melting snow on a sidewalk, driveway, or other surface. The heating mat includes a flexible body having a heating assembly embedded therein configured to melt snow that falls thereon. The heating assembly preferably includes one or more electrical resistance wires affixed within the body portion and a power source electrically connected thereto to provide electrical power to drive the heating assembly. The heating assembly further includes one or more controls, such as an activation switch, a temperature control switch, and a timer. The timer is configured to allow a user to designate a fixed period of time for the heating assembly to be activated.

### CROSS REFERENCE TO RELATED APPLICATION

This application claims the benefit of U.S. Provisional Application No. 62/059,326 filed on Oct. 3, 2014. The above identified patent application is herein incorporated by reference in its entirety to provide continuity of disclosure.

### BACKGROUND OF THE INVENTION

### Field of the Invention

The present invention relates to snow removal equipment. More specifically, the present invention pertains to an improved heating mat that is configured to be placed on a driveway, sidewalk, or other surface before snowfall occurs so as to melt snow that falls thereon.

Snow and ice buildup on driveways has long been a nuisance in areas having colder climates. However, snow removal is often considered necessary as it allows for the roads to be safer. While public roads are handled by governments and other institutions, private driveways often need to be cared for by individual households. This snow removal often is considered very taxing and time consuming. Although shoveling snow seems pretty straightforward, there often is numerous health risks as it is quite extensive manual labor is required. It may be difficult or impossible for some people to shovel or remove snow, such as the elderly or handicapped individuals. Therefore, there exists a need for a heating mat that is placed on a driveway before anticipated snowfall configured to melt snow that falls thereon. In this way, a user is not required to shovel snow after snowfall.

Devices were found in the prior art that relate to ice melting blankets or coverings. Such devices have various configurations and various heating elements for melting snow that falls thereon. These devices, however, fail to provide a heating mat having a plurality of apertures therein configured to allow melted snow to drain therethrough. Furthermore, these devices fail to provide a timer that allows a user to preset a designated period of time for activation of the heating mat.

The present invention provides a heating mat configured to be placed flush against a driveway before anticipated snowfall. The heating mat is preferably rectangular in shape, however, it is contemplated that the heating mat can be configured to fit a variety of different sizes and shapes of driveways. The heating mat includes a heating assembly embedded within the heating mat configured to melt snow and ice that falls thereon. The heating mat includes a plurality of apertures aligned in rows, which allow melted snow to be drained therethrough. The heating assembly includes a serpentine pattern of resistance wires configured to heat the heating mat and is electrically connected to a power source to drive the heating assembly. The heating assembly further includes a control panel having an activation switch, a temperature control switch, and a timer configured to control the heating assembly.

It is therefore submitted that the present invention is substantially divergent in design elements from the prior art, and consequently it is clear that there is a need in the art for an improvement to heating mats. In this regard, the instant invention substantially fulfills these needs.

### SUMMARY OF THE INVENTION

In view of the foregoing disadvantages inherent in the known types of heating mats now present in the prior art, the present invention provides a new and improved heating mat wherein the same can be utilized for preventing snow and ice from accumulating on a surface, such as a driveway or sidewalk, among others.

It is therefore an object of the invention to provide a new and improved heating mat that has all of the advantages of the prior art and none of the disadvantages.

Another object of the present invention is to provide a new and improved heating mat that is configured to be placed on a driveway, sidewalk, deck, or other similar area prior to a snowstorm.

Yet another object of the present invention is to provide a new and improved heating mat that is configured melt snow that falls thereon.

Still yet another object of the present invention is to provide a new and improved heating mat, wherein a heating assembly having an elongated resistance wire embedded within the heating mat in a serpentine pattern.

A further object of the present invention is to provide a new and improved heating mat, wherein the heating assembly is electrically connected to a control panel.

Yet a further object of the present invention is to provide a new and improved heating mat, wherein the control panel includes an activation switch, a timer configured to activate the heating assembly for a set period of time, and a temperature control switch configured to regulate the temperature of the heating assembly.

Still yet another object of the present invention is to provide a new and improved heating mat wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a perspective view of the heating mat in use on a driveway.

FIG. 2 shows a partially disassembled view of the heating mat.

FIG. 3 shows a schematic diagram of the control panel of the heating mat.

### DETAILED DESCRIPTION OF THE INVENTION

References are made herein to the attached drawings. Like reference numerals are used throughout the drawings to depict like or similar elements of the heating mat. For the purposes of presenting a brief and clear description of the present invention, the preferred embodiment will be discussed as used for preventing snow and ice from accumulating on a surface, such as a driveway, sidewalk, or deck, among others. The figures are intended for representative purposes only and should not be considered to be limiting in any respect.

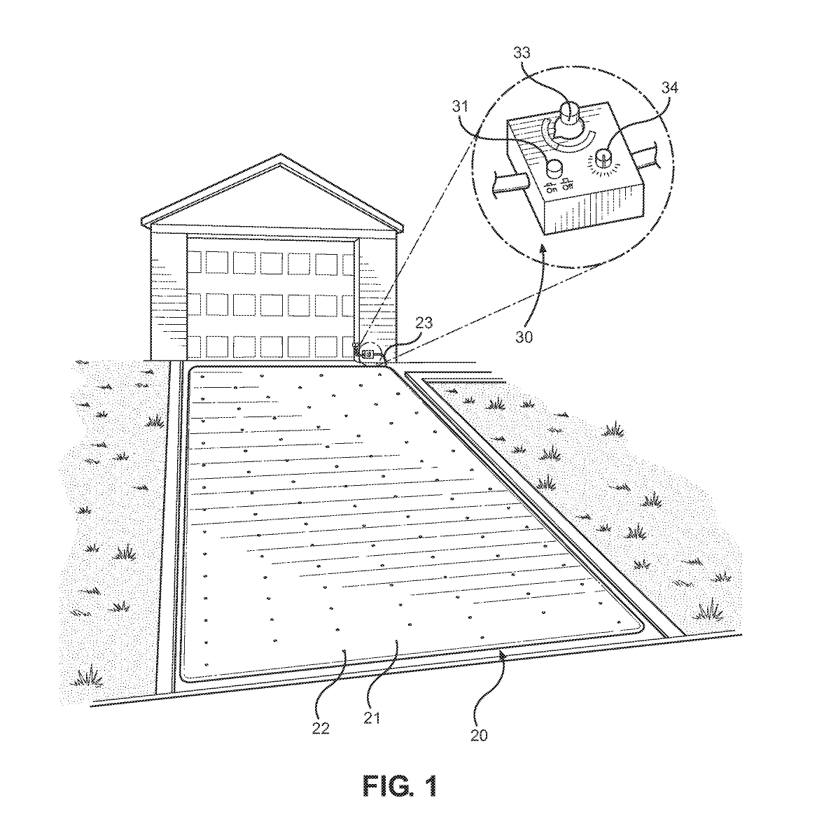

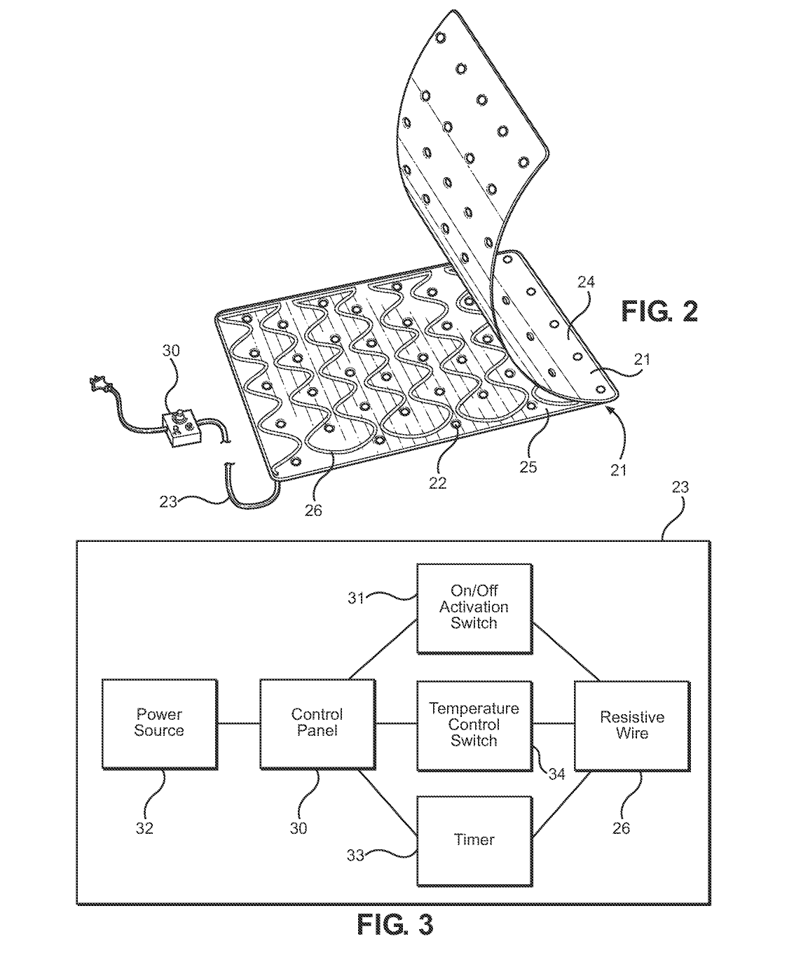

Referring now to FIGS. 1 and 2, there are shown views of the heating mat. The heating mat 20 comprises a flexible body portion 21 adapted to cover a surface, such as a driveway, sidewalk, porch, deck, or other area. The body portion 21 contours to the shape of the surface so that the body portion 21 is flush thereagainst. The body portion 21 is preferably substantially rectangular in configuration so as to match the shape of conventional sidewalks and driveways. However, in alternate embodiments, the body portion 21 may have any of various configurations so as to cover a desired area. The body portion 21 is configured to be portable, wherein the body portion 21 can be rolled out for its intended use or rolled back up to be stored away. In this way, the heating mat 20 is particularly convenient when being removed and stored away during other seasons. Preferably, the body portion 21 is composed of a neoprene rubber or a similar material, wherein the material will not melt or burn when the heating assembly therein is heated.

A plurality of apertures 22 are disposed on the body portion 21, wherein the apertures 22 allow melted snow on the upper surface of the body portion 21 to drain therethrough. In this way, the plurality of apertures 22 prevent any accumulation of melted snow on the body portion 21. The plurality of apertures 22 are preferably aligned in one or more rows that extend throughout the body portion 21 so that the apertures 22 are evenly distributed over the body portion 21. It is likewise contemplated that other suitable patterns and formations for alignment of the plurality of apertures 22 are suitable.

The heating mat 20 includes a heating assembly 23 that is configured to melt snow, sleet and other similar inclement weather that falls thereon. The heating assembly 23 is disposed between an upper layer 24 and a lower layer 25 of the body portion 21. The heating assembly 23 preferably includes a thermoelectric resistance wire 26 that generates heat by having an electric current pass therethrough. Preferably, the elongated resistance wire 26 is affixed in a substantially serpentine pattern throughout the body portion 21, however, it is anticipated that those of ordinary skill in the art will readily envision other shapes and patterns for affixing the resistance wire 26 to allow for efficient heating. Those alterations and modifications are deemed to be within the spirit and scope of the inventive embodiments described herein.

Preferably, the resistance wire 26 includes an electric conductor encased in an insulated jacket. Some exemplary electric conductors can include copper, aluminum, silver and any other equivalents. Some exemplary plastics for the insulated jacket include, but are not limited to: polyisoprene, polychloroprene (Neoprene), isobutylene, isoprene, nitrile rubber, polyacrylic rubber, silicone rubber, fluorosilicone rubber, perfluoroelastomers and ethylene-vinyl acetate (EVA). In some embodiments, the resistance wire 26 includes an inner conductor of nickel chromium wire, covered with a layer of insulation, an intermediate layer of braid of tinned copper, and an outer insulation jacket. Preferably, in these embodiments, the layer of insulation and the insulation jacket is composed of silicone rubber, however, other suitable material for insulation is contemplated.

As it will be readily apparent to those skilled in the art, any suitable material that may achieve the above stated objects of the present invention will suffice. Those of ordinary skill in the art will readily envision other sizes, shapes, and materials used for various components of the resistance wire 26. These variations, alterations, and modifications may be varied without departing from the scope and spirit of the inventive embodiments described herein.

Referring now to FIG. 3, there is shown a schematic diagram of the heating assembly 23 of the heating mat 20. The heating assembly 23 comprises an electrical resistance wire 26 electrically connected to a power source 32, which is configured to provide electrical power to the electrical resistance wire 26. The heating assembly 23 further includes a control panel 30, which includes an activation switch 31 that is designed to activate and deactivate electrical communication between the electrical resistance wire 26 and the power source 32.

The control panel 30 further includes a timer 33 that allows users to designate a certain desired period of time for heating, wherein the heating assembly 23 is configured to deactivate when the period of time set has elapsed. For example, the user may set the timer for one hour, such that the heating assembly 23 will be activated for one hour and will automatically deactivate once an hour has elapsed. In this way, the user may allow the heating assembly 23 to operate while the user is sleeping or while the user is away from home without having to return in order to manually deactivate the heating assembly 23.

In some embodiments, the control panel 30 also includes a temperature control switch 34, wherein the temperature control switch 34 is configured to manipulate the heating intensity of the heating assembly 23. The temperature control switch 34 can be set to an elevated temperature when heavy snowfall is expected or when ice has already accumulated on the heating mat. The temperature control switch can be adjusted to a relatively low temperature when only light snowfall is anticipated.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A heating mat, comprising:
a flexible body portion having a heating assembly therein;
a plurality of openings on said body portion configured to allow liquid to pass therethrough.

2. The heating mat of claim 1, wherein said body portion comprises a lower layer, and upper layer, and wherein said heating assembly is disposed between said upper layer and said lower layer.

3. The heating mat of claim 1, wherein said heating assembly comprises a thermoelectric resistance wire configured to generate heat by having an electric current pass therethrough.

4. The heating mat of claim 3, wherein said thermoelectric resistance wire is arranged in a serpentine pattern.

5. The heating mat of claim 1, wherein said heating assembly further comprises a control panel having an activation switch configured to activate electrical communication between a power source and said heating assembly.

6. The heating mat of claim 5, wherein said control panel further comprises a timer configured to allow a user to designate a fixed period of time for said heating assembly to be activated.

7. The heating mat of claim 5, wherein said control panel further includes a temperature control switch, wherein said temperature control switch is configured to allow a user to adjust a temperature of said heating assembly.
